(19) United States
(12) Patent Application Publication
(10) Pub. No.: US 2008/0298248 A1
(43) Pub. Date: Dec. 4, 2008

(54) Method and Apparatus For Computer Network Bandwidth Control and Congestion Management

(76) Inventors: Guenter Roeck, San Jose, CA (US); Humphrey Liu, Fremont, CA (US)

Correspondence Address: COOLEY GODWARD KRONISH LLP;ATTN: Patent Group, Suite 1100, 777 - 6th Street, NW, Washington, DC, 20001, US

(21) Appl. No.: 12/127,658

(22) Filed: May 27, 2008

Related U.S. Application Data
(60) Provisional application No. 60/940,433, filed on May 28, 2007.
(60) Provisional application No. 60/950,034, filed on Jul. 16, 2007.
(60) Provisional application No. 60/951,639, filed on Jul. 24, 2007.

(51) Int. Cl. H04L 12/56

(52) U.S. Cl. 370/237

(57) ABSTRACT

In one embodiment, a network switch includes first logic for receiving a flow, including identifying a reaction point as the source of the data frames included in the flow. The network switch further includes second logic for detecting congestion at the network switch and associating the congestion with the flow and the reaction point, third logic for generating congestion notification information in response to congestion, and fourth logic for receiving control information, including identifying the reaction point as the source of the control information. The network switch further includes fifth logic for addressing the congestion notification information and the control information to the reaction point, wherein the data rate of the flow is based on the congestion notification information and the control information. The content of the data frames included in the flow is independent of the congestion notification information and the control information in a first mode of the network switch.

### CROSS REFERENCES TO RELATED APPLICATIONS

The present application claims the benefit of the following commonly owned U.S. provisional patent applications, all of which are incorporated herein by reference in their entirety: (1) U.S. Provisional Patent Application No. 60/940,433, Attorney Docket No. TEAK-012/00US, entitled “Method and Apparatus for Computer Network Congestion Management,” filed on May 28, 2007; (2) U.S. Provisional Patent Application No. 60/950,034, Attorney Docket No. TEAK-011/00US, entitled “Method and Apparatus for Computer Network Congestion Management with Improved Data Rate Adjustment,” filed on Jul. 16, 2007; and (3) U.S. Provisional Patent Application No. 60/951,639, Attorney Docket No. TEAK-012/00US, entitled “Method and Apparatus for Computer Network Congestion Management with Determination of Congestion at Variable Intervals,” filed on Jul. 24, 2007.

### FIELD OF THE INVENTION

The invention generally relates to the field of protocols and mechanisms for congestion management in a Layer 2 computer network, such as Ethernet.

### BACKGROUND OF THE INVENTION

A computer network typically includes multiple computers connected together for the purpose of data communication. As a result of increasing data traffic, a computer network can sometimes experience congestion. Several proposals have been made to address congestion in Ethernet networks. These proposals can be characterized through two sets of parameters: (1) tagging versus non-tagging; and (2) forward notification versus backward notification.

A tagging protocol is a protocol that tags “normal” data traffic with congestion-related control information. Some protocols may require in-flow packet modification and, thus, re-calculation of packet checksums, which is typically undesirable in a Layer 2 switch. A non-tagging protocol is one that keeps congestion management separate from data traffic.

In forward notification protocols, congestion-related control information is sent to a Layer 2 endpoint of a transmission, which reflects it to a Layer 2 origin of a packet. A backward notification protocol sends congestion-related control information back to the Layer 2 origin of the packet, and typically does not involve the Layer 2 endpoint (e.g., receiver) in the packet exchange. A specific disadvantage of forward notification protocols is that their reaction time will typically be slower than backward notification protocols, since congestion-related control packets often have to travel a greater distance and number of hops through the Layer 2 network. Also, any network bottlenecks may result in loss of congestion-related control packets, which in turn can cause protocol failures. While this can also occur with backward notification protocols, the probability of congestion-related control packet loss is typically higher with forward notification protocols.

Both forward notification and tagging congestion management protocols have in common that the receiving Layer 2 endpoint should support the protocol, since that endpoint typically either removes a tag from received data packets, or reflects congestion-related control packets to a Layer 2 source. In addition, these protocols make a congestion management coprocessor implementation difficult, if not impossible, since these protocols generally act upon and possibly modify packets in the data path.

The above-described disadvantages of tagging protocols can be at least partially offset by the creation of an implicit closed control loop in such protocols. Congestion management information included in tagged data packets may be responsive to congestion notification information in a backward congestion notification packet, and vice versa. Because data packets are not tagged in non-tagging protocols, this mechanism is typically not available in non-tagging protocols.

An additional characteristic of congestion management protocols is the type of signaling supported. A simple protocol may only support “negative” signals that cause the traffic source, or reaction point to congestion, to reduce its data rate. If no negative signals are received for a period of time, the reaction point may automatically increase its data rate. While relatively simple to implement, this protocol may recover available bandwidth very slowly and/or after a relatively long period of time. In some situations, such as under transient congestion conditions caused by bursty traffic, the use of this protocol may result in significant network under-utilization. Also, such a protocol depends to some degree on maintaining network instability, since the rate control mechanism depends on auto-increasing the data rate until a request to decrease the data rate is received. For these reasons, a well-designed congestion management protocol should also provide positive feedback that causes the traffic source to increase its data rate faster than it could do without such positive feedback.

Another characteristic of congestion management protocols is the speed with which congestion is detected at a congestion point and reported to a reaction point. One approach used to detect and report congestion is to sample queue parameters such as queue depth per constant time interval, and to report the sampled queue parameters at that same time interval. If the time interval is too long, the congestion management protocol may not respond sufficiently quickly to rapidly changing network conditions to avoid a significant degradation in network performance, such as a reduction in network throughput and/or an increase in packet loss. On the other hand, if the time interval is too short, the data throughput of the network may be significantly reduced due to the increased volume of congestion-related control packets. For these reasons, a well-designed congestion management protocol should take into account both network overhead and reaction time to rapidly changing network conditions.

Another characteristic of network congestion management protocols is the consistency of protocol performance over the wide range of reaction points that may share a congestion point. Control theory indicates that a control loop, and thus a congestion management protocol, should adjust its gain, i.e. the rate at which changes occur in data rates, based on the round-trip time (RTT) between each reaction point and the congestion point. If such gain adjustment does not occur, protocol capabilities will be limited, and the protocol will work well for a limited RTT range. A protocol not adjusting for RTT may, for example, only work for small values of RTT (e.g., it may perform well up to 200 microsecond RTT on a 10 Gigabit link), or it may have marginal performance over a somewhat larger RTT range (e.g., up to 500 microsecond RTT on a 10 Gigabit link). For these reasons, a well-designed congestion management protocol should provide a mechanism for taking RTT into account when controlling data rates.

Another characteristic of network congestion management protocols is the fairness of bandwidth allocation between sources sharing the resources of a congestion point. Data rate calculations and adjustments have typically been done at the source where data is inserted into the network, otherwise known as the reaction point to congestion. This approach can improve protocol scalability and reduce protocol complexity, but at the cost of unfairness in data rate adjustment, since each reaction point adjusts its data rate independently of other reaction points. On the other hand, computing source data rates at a congested switch can result in over-reaction to the onset and cessation of congestion and thus result in network instability. For these reasons, a well-designed congestion management protocol should take into account both fairness of bandwidth allocation and network stability.

Another characteristic of network congestion management protocols is that such protocols react to a given condition in the network. Such protocols typically do not proactively manage available network bandwidth. However, proactive bandwidth management is desirable in today's networks. For example, a given network might be built around an application where a request is sent to a large number of servers, where each server returns part of the result to a central agent, which then merges the result. In such a network, substantial traffic bursts may be seen as the result of a request. Such bursts may overwhelm even the fastest reactive congestion management protocol, causing packet loss and/or congestion throughout the network. In a network that has to adhere to Service Level Agreements (SLA), such as well-defined throughput levels, maximum latency, or maximum jitter, reactive congestion management approaches may lead to SLA violations. For these reasons, a well-designed congestion management protocol should be proactive in managing available network bandwidth.

In view of the foregoing, there is a need for an improved protocol for congestion management in a Layer 2 computer network. It would be desirable for this congestion management protocol to combine at least some, if not all, of the advantages described above while minimizing any disadvantages, and at the same time remain easy to implement at both the congestion point and the reaction point.

### SUMMARY

In one embodiment, a network switch includes first logic for receiving a flow, including identifying a reaction point as the source of the data frames included in the flow. The network switch further includes second logic for detecting congestion at the network switch and associating the congestion with the flow and the reaction point, third logic for generating congestion notification information in response to congestion, and fourth logic for receiving control information, including identifying the reaction point as the source of the control information. The network switch further includes fifth logic for addressing the congestion notification information and the control information to the reaction point, wherein the data rate of the flow is based on the congestion notification information and the control information. The content of the data frames included in the flow is independent of the congestion notification information and the control information in a first mode of the network switch.

In another embodiment, a network switch includes first logic for receiving congestion notification information associated with a congestion point and a flow. The network switch generates the flow, and the congestion notification information is addressed to the network switch. The network switch further includes second logic for generating control information and addressing the control information to the congestion point, and third logic for generating the data frames included in the flow, where in a first mode of the network switch the content of the data frames included in the flow is independent of the congestion notification information and the control information. The network switch further includes fourth logic for receiving the control information, and fifth logic for determining a data rate of the flow based on the congestion notification information and the control information.

In one embodiment, a method includes detecting congestion at a congestion point, where a flow causing the congestion originates at a reaction point, and generating congestion notification information based on the congestion, where the congestion notification information is addressed to the reaction point. The method also includes identifying control information at the congestion point that originates at the reaction point, and returning the control information to the reaction point. The method further includes processing the flow, where the content of the data frames included in the flow is independent of the congestion notification information. The data rate of the flow is determined based on the congestion notification information and the control information.

### BRIEF DESCRIPTION OF THE DRAWINGS

For a better understanding of the nature and objects of some embodiments of the invention, reference should be made to the following detailed description taken in conjunction with the accompanying drawings.

FIG. 1 illustrates a network in which congestion notification information is sent to sources from a congestion point, in accordance with embodiments of the present invention;

FIG. 2A illustrates data frames and rate control frames traveling between a reaction point and at least one congestion point before detection of congestion, in accordance with embodiments of the present invention;

FIG. 2B illustrates data frames, congestion notification frames, and rate control frames traveling between a reaction point and at least one congestion point during congestion, in accordance with embodiments of the present invention;

FIG. 2C illustrates data frames, congestion notification frames, and rate control frames traveling between a reaction point and at least one congestion point after congestion has ended but before stabilization of the network, in accordance with embodiments of the present invention;

FIG. 3 illustrates an example of a format of a congestion notification frame, in accordance with embodiments of the present invention;

FIG. 4 illustrates an example of a format of a rate control frame transmitted by a congestion point to a reaction point, in accordance with embodiments of the present invention;

FIG. 5 illustrates an example of a format of a rate control frame transmitted by a reaction point to a congestion point, in accordance with embodiments of the present invention;

FIG. 6 illustrates a logical block diagram of a switch and an associated coprocessor that implements congestion management, in accordance with embodiments of the present invention.

### DETAILED DESCRIPTION

One embodiment of the invention provides a protocol to implement congestion management in a Layer 2 computer network, such as Ethernet. Described herein are a congestion management protocol and a congestion management module.

Embodiments of the protocol to implement congestion management may support both tagging and non-tagging operation, backward notification for signaling, adjustment of data rates of flows that is responsive to RTT between a reaction point and a congestion point, positive feedback to increase the data rate as well as negative feedback to reduce the data rate, congestion point based data rate calculations and adjustments, and variable sampling rates when monitoring for congestion at a congestion point.

Another embodiment of the invention provides an apparatus and method to implement congestion management in a Layer 2 switch, such as using a coprocessor device that operates in conjunction with a switch core chip. Described herein are switch chip specifications as well as interface specifications. A switch chip implementation is also provided as an example. Advantageously, embodiments of the invention allow for reduced cost for a switch core chip, and allow switch chip manufacturers to build congestion management-enabled switch chips, without having to wait for a future standard. Embodiments of the invention also allow switch chip core functionality to be separated from enhanced functionality, such as congestion management.

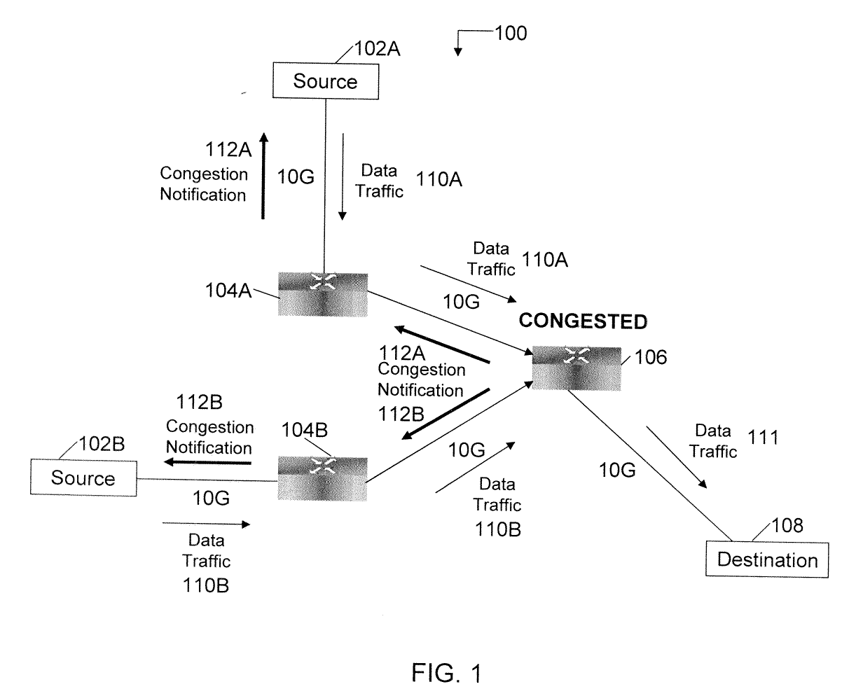

FIG. 1 illustrates a network 100 in which congestion notification information 112 is sent to sources 102 from a congestion point 106, in accordance with embodiments of the present invention. Source 102A transmits data traffic 110A through switch 104A to congested switch 106. Similarly, source 102B transmits data traffic 110B through switch 104B to congested switch 106. Congested switch 106 queues the incoming data traffic 110 and transmits at least a portion of data traffic 110 as data traffic 111 to destination 108.

In one embodiment, switches 104 and 106 operate at Layers 1 and 2 of the Open Systems Interconnection (OSI) reference model for networking protocol layers. When processing data traffic 110, switches 104 and 106 may access physical layer and data link layer information without accessing information at higher layers of the OSI model. In one example, switches 104 and 106 are Ethernet switches with 10 Gigabit Ethernet interfaces, as defined by an Institute of Electrical and Electronics Engineers (IEEE) standard protocol such as 10 Gb/s Ethernet (IEEE 802.3ae-2002).

In one embodiment, each of data traffic 110A and 110B is a Layer 2 traffic flow. For example, each of data traffic 110A and 110B may be tagged with a separate virtual local area network (VLAN) identifier as defined by an IEEE standard protocol such as IEEE 802.1Q-2005. Switch 106 may queue data traffic 110A and 110B in separate physical queues, such as by VLAN identifier. Alternatively, switch 106 may queue data traffic 110A and 110B in separate logical queues within the same physical queue. Switch 106 monitors the at least one queue containing data traffic 110A and 110B for congestion. When switch 106 detects congestion, switch 106 is known as the congestion point.

In one embodiment of the present invention, switch 106 may monitor congestion at variable intervals, depending on the level of congestion. In such a manner, a faster reaction time and a faster convergence to an acceptable performance level can be achieved. In a typical implementation, the switch determines in pre-configured or selected intervals if it is congested on a specific output interface or queue. This interval may be a time interval, a sampling interval, or a probability. The interval may be fixed (e.g., after 100,000 bytes have been sent in an interface, or with a probability of 1% per received packet), or it may be variable. In the latter case, a greater number of congestion notification messages can be created if the congestion reaches a higher level. This approach can result in a faster reaction time if congestion is high, which is desirable to achieve faster convergence to an acceptable performance level. One possible implementation is to use a dynamic probability derived from the current congestion level to determine such flexible or variable reaction intervals. However, to reduce switch implementation complexity, it can be desirable to avoid having to calculate this dynamic probability for each received packet. Another implementation is to use a configured base sampling interval (e.g., sample once every 100,000 bytes), and re-calculate the sampling interval each time a sample is taken, depending on the current level of congestion. The sampling interval value can be set to a lower value (e.g., sample once every 50,000 bytes) if the level of congestion is high, and can be reset to the base value if the level of congestion is low. The desired sampling interval, depending on the level of congestion, can be pre-calculated at startup time and stored in a table or the like, or it can be calculated on-the-fly as factor of the current level of congestion whenever a sample is taken. For example, if the level of congestion is expressed as a number between 1 and 10, where 10 is the highest level of congestion, the sampling interval can be calculated as: Sampling Interval=Base Sampling Interval/Congestion Level, resulting in a sampling interval ranging from 10,000 bytes to 100,000 bytes if the base sampling interval was configured to 100,000 bytes. It is desirable for the sampling interval to be randomized after calculation to avoid self-synchronization of sampling intervals across switches, which may cause protocol instability. A dynamic timer interval may be used instead of, or in conjunction with, a dynamic sampling interval to achieve similar results.

Switch 106 may detect congestion on a given interface and/or transmit queue when monitored queue parameters such as queue fill level and queue fill level deviation from a desired queue fill level exceed a threshold. These monitored parameters may be filtered and/or averaged over time. When congestion is detected, it is desirable for switch 106 to associate this congestion with a flow of data traffic 110 and a source 102 of the flow so that congestion notification information 112 referencing the flow causing the congestion can be sent by switch 106 to source 102. For example, data switch 106 can identify source 102A as the source of VLAN flow 110A based on the Ethernet source address of received frames including flow identification for VLAN flow 110A. Data switch 106 may associate the congestion with VLAN flow 110A by monitoring separate physical or logical queues per VLAN flow.

When switch 106 detects congestion due to, for example, data traffic 110A and 110B, switch 106 may then send congestion notification information 112A and 112B to sources 102A and 102B, respectively. Sources 102A and 102B are the reaction points to congestion. In one embodiment, the congestion notification is a backward notification and does not require tagging of data packets. The congestion notification information may be included in a packet, and may include information indicating the severity of the congestion. In one embodiment, the congestion notification is accessible at the data link layer of the OSI model. In a typical implementation, this information will include a queue offset value, Qoff, indicating how much a current queue level in the switch deviates from a desired queue level, and a delta value, Qdelta, indicating how much the current queue level has changed since the last notification message was sent. Another implementation can calculate a direct feedback value, Fb, from Qoff and Qdelta, and send this calculated feedback value as congestion notification information, instead of Qoff and Qdelta. The congestion notification information may also include a suggested data rate that is calculated at switch 106. Switch 106 can calculate this suggested data rate whenever it is about to send congestion notification information to a reaction point, or at pre-determined or selected time intervals. The particular method to calculate the suggested data rate can be implementation dependent, and is typically aligned with the particular method used by reaction points 102A and 102B to calculate the data rates of flows 110A and 110B. It is desirable for data rate adjustments in switch 106 to be less severe than data rate adjustments in reaction points 102A and 102B. Switch 106 can also include a maximum data rate in the congestion notification information. This maximum data rate may be a link data rate associated with an output interface of switch 106, the link capacity currently available for a given output queue of switch 106, or a value that is configured or otherwise determined. In conjunction with the foregoing, the congestion notification information can also include information used by a receiver of the congestion notification information to identify the congestion point in question. Switch 106 may also include information about its current output interface utilization in the congestion notification information, for example as percentage of the available data rate or as absolute number. The congestion notification information may further include additional information about the congestion, such as some or all MAC addresses of affected reaction points. The congestion notification information may also include information received from sources 102A and 102B.

In the example of FIG. 1, reaction points 102 reduce the data rate for flows 110A and 110B sent through congestion point 106 as identified in the congestion notification information 112. In one embodiment, the congestion notification information 112A and 112B is addressed to reaction points 102A and 102B, respectively. As a result, the backward congestion notification information 112 typically does not traverse destination 108 on the way to reaction points 102. If data traffic 110 is untagged, then the content of the data frames included in data traffic 110 is independent of, or does not change as a result of, the congestion notification information 112. On the other hand, if data traffic 110 is tagged, then the content of the data frames included in data traffic 110 may change as a result of the congestion notification information 112.

The reaction points 102 use the information provided by the congestion point 106, specifically Qoff and Qdelta (or Fb), to calculate a local data rate. Various methods to perform this data rate calculation can be used. In one embodiment, the suggested data rate is included in the congestion notification information sent by the congestion point 106. After the reaction point 102 derives the locally calculated data rate, the suggested data rate may be merged at a pre-configured or selectable weight, thereby deriving a new data rate for the data traffic 110. For example, if the weight is defined to be a value between 0 and 1, the reaction point 102 can calculate its new data rate for the data traffic 110 as:

| | |
|---|---|
| new rate = | (<locally calculated rate> * (1-weight) + |
| | <suggested rate by congestion point> * weight) |

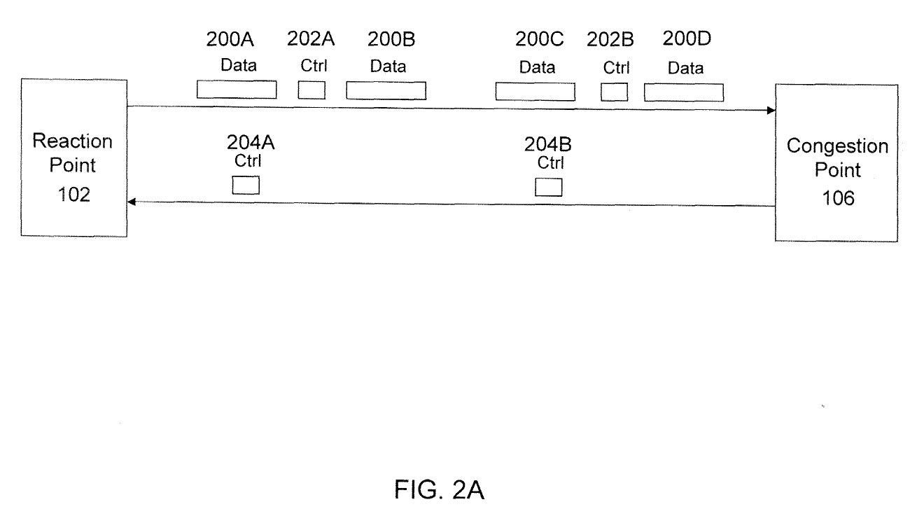

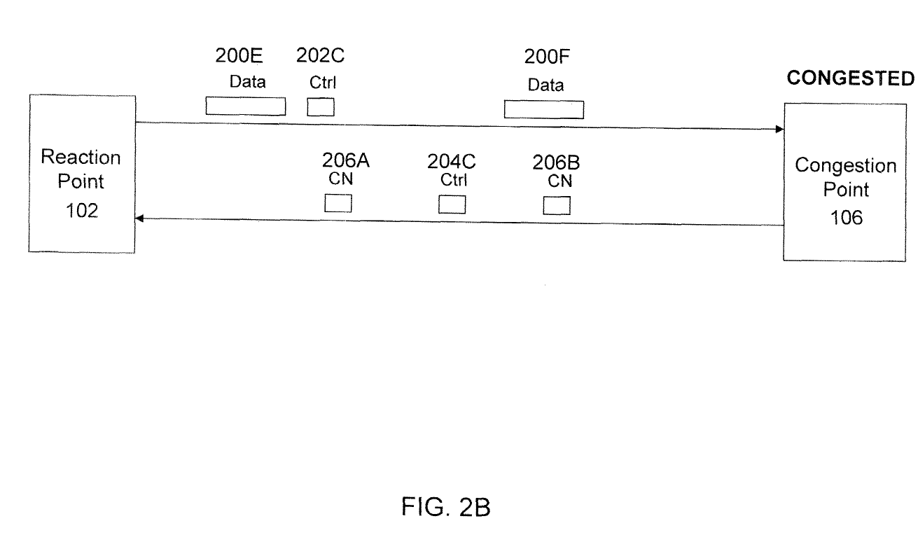

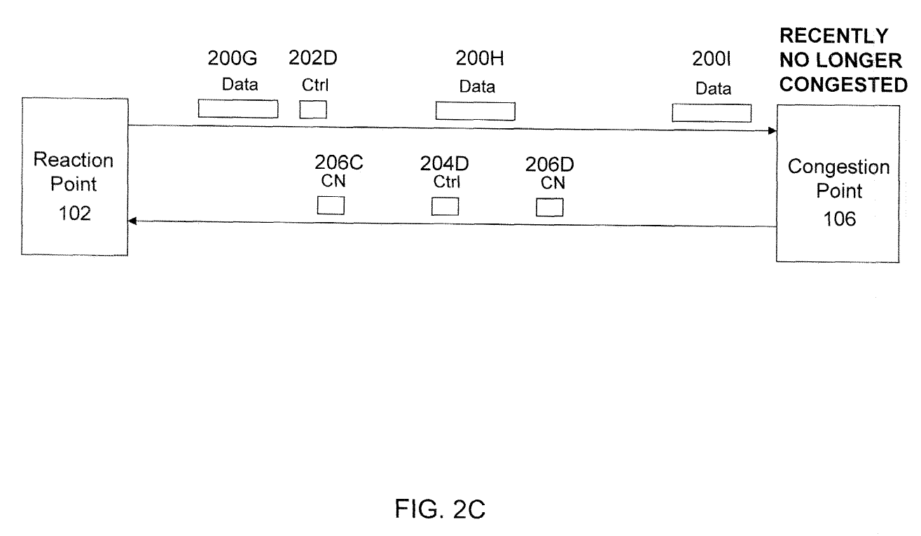

FIG. 2A illustrates data frames 200A-D and rate control frames 202A-B and 204A-B traveling between a reaction point 102 and at least one congestion point 106 before detection of congestion, in accordance with embodiments of the present invention. Data frames 200A-D are associated with a flow 200. Rate control frames 202 are generated by reaction point 102 and addressed to congestion point 106, while rate control frames 204 are generated by congestion point 106 and addressed to reaction point 102. Rate control frames 202 and 204 are used in a non-tagging congestion management protocol to enable communication of control information that can facilitate the control of the data rate of flow 200, while enabling data frames 200 to remain independent of both congestion notification information and control information included in the rate control frames 202 and 204. This control information may include but is not limited to suggested or measured data rates for flow 200, requests to reduce or increase the data rate of flow 200, and information related to RTT computation between reaction point 102 and congestion point 106 for adjusting the data rate of flow 200. At least some of this control information may be received at congestion point 106, identified as being sent from reaction point 102, and sent back to reaction point 102 from congestion point 106. In one embodiment, the control information is accessible at the data link layer of the OSI model. Rate control frames 202 and 204 may be sent even when there is no detected congestion at congestion point 106.

FIG. 2B illustrates data frames 200E-F, congestion notification frames 206A-B, and rate control frames 202C and 204C traveling between a reaction point 102 and at least one congestion point 106 during congestion, in accordance with embodiments of the present invention. Congestion notification information in congestion notification frames 206 results in negative feedback to, and a resulting rate decrease to flow 200 at reaction point 102. Rate control frames 202 and 204 are used in a non-tagging congestion management protocol, in addition to congestion notification frames 206, to enable communication of control information that can facilitate the control of the data rate of flow 200, as described for FIG. 2A.

FIG. 2C illustrates data frames 200G-I, congestion notification frames 206C-206D, and rate control frames 202D and 204D traveling between a reaction point 102 and at least one congestion point 106 after congestion has ended but before stabilization of the network, in accordance with embodiments of the present invention. In one embodiment, congestion notification frames 206 are no longer sent after congestion has ended at congestion point 106. After a time period without receiving any congestion notification frames 206, reaction point 102 may begin to automatically increase the data rate of flow 200. This data rate increase can be computed locally or configured in some manner. Another way to increase the data rate of flow 200 is to calculate an offset between the current data rate of the flow 200 and the maximum data rate, if received from the congestion point 106 in the congestion notification information, and then increase the data rate of the flow 200 by a given percentage of this calculated rate difference. In addition, reaction point 102 may request additional bandwidth for the flow 200 in rate control frame 202D. If congestion point 106 grants this request for additional bandwidth, this results in positive feedback to, and a resulting rate increase to flow 200 at reaction point 102.

In conjunction, the reaction point 102 may start to request the congestion status of congestion point 106 using rate control frame 202D. The rate of rate control frames 202 can be implementation dependent. To guide the switch in adjusting its internal data rate calculation, the rate control frame 202D may include the current data rate used by the reaction point 102 to send data in the affected data flow 200.

If the congestion point 106 receives a congestion status request in rate control frame 202D, the congestion point 106 replies in rate control frame 204D with its current congestion status on the affected transmit queue. Rate control frame 204D may also include a newly calculated (e.g., updated) suggested data rate to be used by the reaction point 102 to adjust the transmission data rate of the flow 200. To avoid over-reaction, the switch 106 should simply reply to congestion status requests if the congestion condition is less severe than before, and if it expects the reaction point 102 to increase the data rate of the flow 200 as a result.

When receiving a reply to a congestion status request, the reaction point 102 may increase the data rate of the flow 200 if the congestion condition has been resolved, or reduce it further if the congestion condition still exists. The reaction point 102 may use the suggested data rate received from the congestion point 106 to adjust the data rate of the flow 200.

Similar behavior can be achieved if the congestion point 106 provides information about its current utilization in the rate control frame 204D. The reaction point 102 can use this information to adjust the transmit rate of the flow 200. For example, if congestion point 106 sends a rate control frame 204D indicating that its output interface is only 50% utilized, the reaction point 102 could increase the transmit rate of the flow 200 accordingly, either by 100% to match the current utilization of congestion point 206, or by a fraction of this value to avoid too-rapid rate changes.

In another embodiment, congestion notification frames 206 may be sent for a short period, such as 50 milliseconds, after congestion has ended at congestion point 106. This enables congestion point 106 to proactively provide positive feedback to reaction point 102 to increase the rate of flow 200 without waiting for a rate increase request from reaction point 102 in control frame 202D. This mechanism may enable a quicker increase in the rate of flow 202 in response to the cessation of congestion at congestion point 106.

There are various functions of control frames 202 that may apply across FIGS. 2A-2C. In one embodiment, reaction point 102 may request additional bandwidth or release bandwidth in control frame 202. Congestion point 106 may identify the request as coming from reaction point 102, then grant or deny the request for additional bandwidth in control frame 204 addressed to reaction point 102. No response by the congestion point 106 may be needed for a release of bandwidth. Congestion point 106 may also proactively increase or decrease the allowable data rate of the flow 200 in control frame 204 addressed to reaction point 102.

In another embodiment, control frames 202 and 204 may facilitate RTT computation. A reaction point 102 should incorporate RTT when adjusting the data rate of flow 200. Per control theory, this adjustment should be a reduction of gain, or rate of adjustment, if RTT increases. For example, assume the non-RTT-adjusted data rate calculation for a reduction in the data rate (e.g., locally calculated rate) of flow 200 is as follows.

Rate=Rate*(1−(Feedback*Gain))

The RTT adjusted data rate might then be

Rate=Rate*(1−(Feedback*(Gain/RTT)))

To obtain RTT using a non-tagging protocol, the reaction point 102 may include a timestamp in control frame 202 to congestion point 106, where the timestamp is obtained from a local time reference at reaction point 102. The congestion point 106 then identifies control frame 202 as coming from reaction point 102, and returns this timestamp in control frame 204 to reaction point 102. Reaction point 102 may compute the RTT as the difference between the values of the local time reference at the time the timestamp is received at reaction point 102, and the returned timestamp.

In some cases, this way of adjusting the data rate of flow 200 for RTT variations may be difficult to implement, since the value for RTT has to be directly calculated and adjusted. This data rate adjustment approach also does not take into account that the requested data rate adjustment is based on the data rate of flow 200 at the reaction point 102 at a previous time, i.e. when the packet was sent that caused the data rate adjustment request to be generated by the congestion point 106.

In one embodiment, the reaction point 102 may use that previous data rate of flow 200, and not the current data rate of flow 200, to determine the new data rate of flow 200 without directly calculating RTT. The reaction point 102 can obtain this previous data rate of flow 200 in various ways. For example, using a non-tagging protocol, the reaction point 102 may include the current transmit data rate of flow 200 in control frame 202 to congestion point 106. The congestion point 106 can return this data rate of flow 200 in control frame 204 to reaction point 102, and reaction point 102 could then use this data rate of flow 200 (now a previous data rate of flow 200) to determine the new data rate of flow 200. Alternatively, the reaction point 102 may include a timestamp in control frame 202 that is returned to the reaction point 102 in control frame 204. The reaction point 102 also keeps a history of rate adjustment requests. Each history entry includes the fields <timestamp, rate>. This history could be kept in a first-in first-out (FIFO) queue or buffer. Whenever control frame 204 is received, the reaction point 102 can then obtain the data rate associated with a given transmit time by reading <timestamp, rate> entries from its history buffer, until it finds a matching entry. Alternatively, the reaction point 102 may include a sequence number in control frame 202 that is used in a similar way to the timestamp above.

If the protocol is a tagging protocol, similar approaches can be used to adjust the data rate of flow 200 for RTT variations. The difference is that the reaction point 102 sends the data rate of flow 200 or the timestamp to congestion point 106 in a tag included in each transmit packet in flow 200, and congestion point 106 returns the data rate of flow 200 or the timestamp to the reaction point 102 in a backward congestion notification packet. One advantage of tagging protocols is that control frames 202 and 204 may be omitted. However, in addition to the disadvantages described earlier, tagging protocols may simply allow the adjustment of the data rate of flow 200 for RTT variations during congestion at congestion point 106, when backward congestion notification packets are being sent to reaction point 102. Nevertheless, it may be desirable for a congestion management protocol to support tagging operation in one mode, and non-tagging operation in a second mode.

If the reaction point 102 uses the previous data rate of the flow 200 to calculate a new data rate of the flow 200, there may be conditions where a rate increase request by the reaction point 102 results in a net data rate decrease. This may happen if the data rate of the flow 200 has since already increased, and the newly calculated data rate is lower than the current data rate. Therefore, the rate adjustment using the previous data rate of the flow 200 should include additional checks to prevent this condition. Specifically, a rate increase request should not result in a rate decrease, and a rate decrease request should not result in a rate increase.

Rate adjustment without direct computation of RTT may be sufficient, if a certain amount of jitter is acceptable for situations with larger RTT. However, there are applications, especially with smaller RTT, where the effect of RTT variations may be significant. If the added complexity is acceptable, and/or if the effects of this jitter are undesirable, the protocol can directly calculate the RTT and adjust its response function by reducing its gain (rate change) as RTT increases. However, since fast reaction to increased load (increased congestion) is desirable, it may be desirable to only reduce the gain for data rate increases, and not for data rate reductions.

When adjusting the data rate of flow 200 for RTT variations, it may also be desirable to perform only one data rate adjustment per RTT interval. Effectively, this approach reduces the gain (rate change) for larger values of RTT without directly calculating the RTT. A practical implementation could, for example, store a timestamp indicating when a rate change was made. In a tagging protocol, it would then only accept another rate change when a rate change request with a matching timestamp is received. In a non-tagging protocol, further rate changes would only be accepted after a response to a rate control frame 202 sent after the previous rate change was received. The effect of this approach to adjusting the data rate of flow 200 for RTT variations is similar to using a previous data rate of the flow 200 when calculating a rate change for the flow 200. However, this approach may not handle network condition changes as well, especially if sudden bursts of traffic cause a large number of rate decrease requests to be sent in a short period of time, such as during congestion in FIG. 2B. A combination of those two methods, where rate decrease requests are handled immediately using the previously described method to calculate the new data rate, and rate increase requests are accepted only once per RTT interval, is more desirable and results in better protocol scalability in scenarios with large RTT.

If the reaction point 102 sends the current data rate of flow 200 in control frames 202 or as part of tagged data packets, protocol operation can further be improved if the congestion point 106 modifies this data rate before returning it to the reaction point 102 in control frames 204. For example, if the current utilization at the congestion point 106 is low, the congestion point 106 could directly modify the current data rate of flow 200 to more quickly increase the data rate of flow 200 beyond that possible simply by providing a suggested data rate for the flow 200.

It is also desirable to proactively manage network bandwidth, to prevent severe congestion from happening in the first place, and to enable the network to adhere to established SLA's. For proactive bandwidth management, the source 102 of traffic in a network such as data flow 200 may identify its demand rate, i.e., the data rate at which the application generating the traffic can send data into the network. This can be implemented by introducing a per-flow throughput counter at the source 102 of the data flow 200. The source 102 also may identify SLA parameters applying to the data flow 200, such as data rate boundaries, maximum latency, and maximum jitter.

In one implementation, the source 102 of data flow 200 can manage its bandwidth needs autonomously. In one embodiment, if source 102 does not require additional bandwidth from the network, source 102 does not request it. Also, if its SLA indicates that source 102 must transmit at least at a certain rate to meet the SLA for flow 200, source 102 does not reduce the rate of flow 200 below that level. If its SLA indicates a maximum jitter, source 102 may ensure that its queue length is limited, to prevent jitter from getting too large.

This approach has several advantages. It enables faster reaction, should the network become severely congested. Since source 102, when reducing the data rate of flow 200 based on data rate reduction requests from congestion point 106, does not have to start at the line rate, but can start at the demand rate for flow 200, the network will converge much faster to a stable state. Also, this approach reduces protocol complexity, since the source 102 does not need to request additional bandwidth from congestion point 106 if source 102 does not have the need to increase the data rate of flow 200.

The data source 102 can calculate additional bandwidth needs by comparing its received data rate with its transmit data rate on flow 200. For simplification, it can also look at its internal queue level, i.e. the amount of queued data, for flow 200. If the queue gets larger, additional bandwidth is needed. If the queue length gets smaller, enough bandwidth is assigned to flow 200 and additional bandwidth is not needed. Thus, there is no need to request additional bandwidth by, for example, sending a bandwidth request to congestion point 106.

A more intelligent bandwidth management protocol may include elements to be implemented in congestion point 106. In such an implementation, data source 102 sends bandwidth requests to congestion point 106, either by asking for additional bandwidth, or by releasing bandwidth that is no longer needed. Such requests should include any available SLA data, such as current bandwidth, guaranteed bandwidth, maximum bandwidth, current latency and jitter, and maximum latency and jitter. If bandwidth is released, the congestion point 106 may record that it has additional bandwidth to distribute. If additional bandwidth is requested, the congestion point 106 may calculate if it has bandwidth available, and may either grant or deny the request. SLA parameters are accounted for in such calculations. The congestion point 106 can also proactively send requests to reduce bandwidth to individual data sources 102, even if congestion point 106 is not (or is not yet) congested, if congestion point 106 concludes that a congestion condition will occur in the near future based on bandwidth requests it had received from other sources 102. This may occur, for example, if congestion point 106 grants bandwidth requests due to SLA agreements, and the sum of the granted bandwidth exceeds the link capacity of a given link.

It should be recognized that a congestion management protocol does not need all features described above to operate correctly. For example, in response to a congestion status request, another embodiment can simply provide basic feedback such as Qoff and Qdelta, without suggested data rate information. In addition, the features described above as being associated with control frames 202 and 204 in a non-tagging congestion management protocol may be distributed across additional types of control frames. For example, timestamp information used to determine RTT may be sent by reaction point 102 and returned by congestion point 106 in an RTT measurement frame that is entirely separate from control frames 202 and 204.

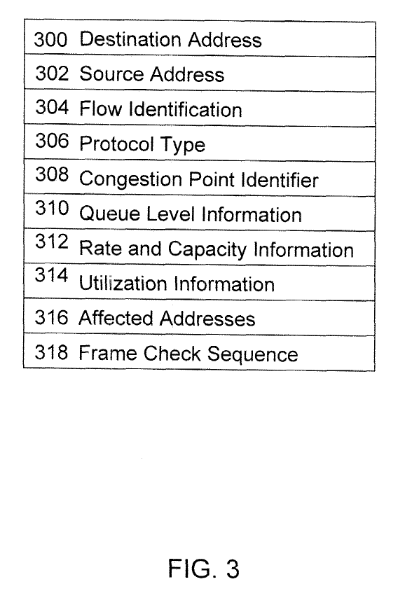

FIG. 3 illustrates an example of a format of a congestion notification frame 206, in accordance with embodiments of the present invention. The destination address 300 is the address of reaction point 102, the source of the data flow 200. The source address 302 is the address of congestion point 106. In one embodiment, the destination address 300 and the source address 302 may be Layer 2 addresses, such as Media Access Control (MAC) addresses. The flow identification 304 is one or more fields that identify a flow. In one embodiment, the flow is a Layer 2 VLAN flow that is identified by an 802.1Q tag. The protocol type 306 may be a currently unassigned EtherType, e.g., as per http://www.iana.org/assignments/ethernet-numbers. The congestion point identifier 308 may be an identifier of a specific congested entity, such as a queue in switch 106. The queue level information 310 is one or more fields, as described earlier. These fields may include at least one of queue level deviation information, queue level change information, and feedback information based on queue level deviation information and queue level change information. The rate and capacity information 312 is one or more fields, as described earlier. These fields may include at least one of a suggested data rate for the flow 200, a link data rate associated with an output interface of the congestion point 106 traversed by the flow 200, and a link capacity associated with a queue containing data frames included in the flow 200. The utilization information 314 may include the utilization of an output interface of the switch 106 traversed by the flow 200. The affected addresses 316 is one or more fields, and may include addresses of switches affected by congestion at the congestion point 106. The frame check sequence 318 typically enables the detection of errors in the congestion notification frame 206.

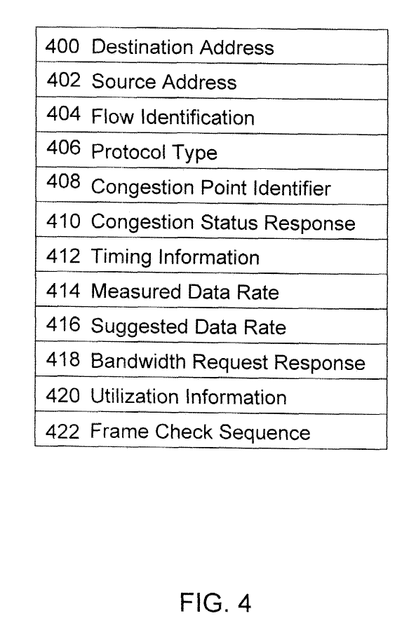

FIG. 4 illustrates an example of a format of a rate control frame 204 transmitted by a congestion point 106 to a reaction point 102, in accordance with embodiments of the present invention. Fields 400-408 correspond to fields 300-308 of FIG. 3. The congestion status response 410 is a response to a congestion status request by reaction point 102 in rate control frame 202. The congestion status response may indicate whether or not the entity referred to by the congestion point identifier 408 is congested or not. The timing information 412 is one or more fields, and may include a timestamp and/or a sequence number, as described earlier. The measured data rate 414 may include the measured data rate of the data flow 200 at the reaction point 102. As described earlier, this measured data rate may be that obtained from a rate control frame 202 received from the reaction point 202, or may be modified by the congestion point 106. Suggested data rate 416 may include a desired data rate of the data flow 200 as computed at the congestion point 106, as described earlier. Bandwidth request response 418 is a response to a bandwidth request by reaction point 102 in rate control frame 202, as described earlier. Fields 420-422 correspond to fields 314 and 318 of FIG. 3.

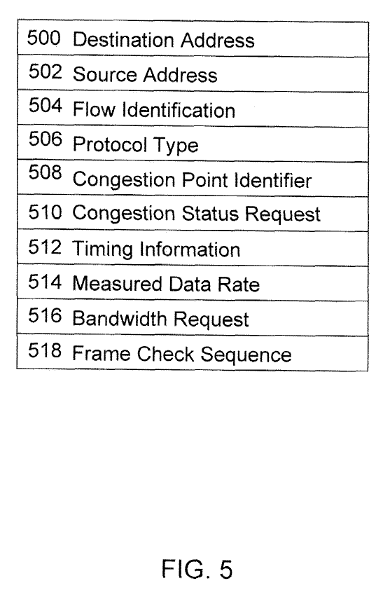

FIG. 5 illustrates an example of a format of a rate control frame 202 transmitted by a reaction point 102 to a congestion point 106, in accordance with embodiments of the present invention. The destination address 500 is the address of congestion point 106. The source address 502 is the address of reaction point 102, the source of the data flow 200. Fields 504-508 correspond to fields 304-308 of FIG. 3. The congestion status request 510 asks for the congestion state of congestion point 106, as described earlier. Fields 512-514 and 518 correspond to fields 412-414 and 422 of FIG. 4. The bandwidth request 516 asks for additional bandwidth or releases bandwidth to congestion point 106, as described earlier.

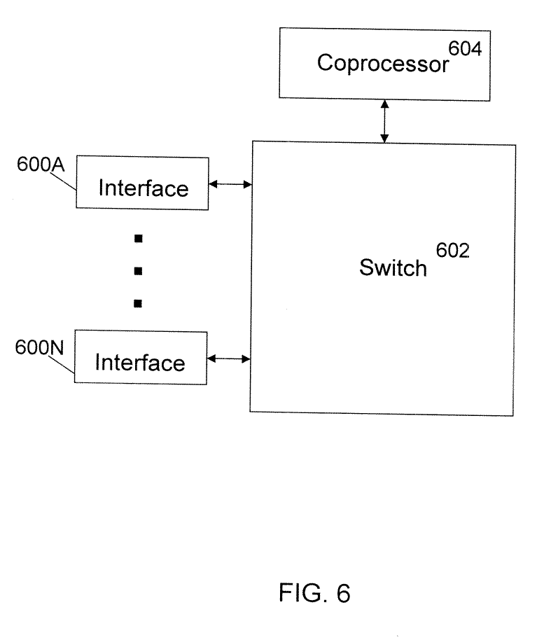

FIG. 6 illustrates a logical block diagram of a switch 602 and an associated coprocessor 604 that implements congestion management, in accordance with embodiments of the present invention. The switch 602 transmits and receives data frames 200 from interfaces 600A-600N. These interfaces may be Layer 2 interfaces, such as 10 Gigabit Ethernet interfaces. In a non-tagging implementation, the switch 602 may also transmit and/or receive congestion notification frames 206, control frames 202, and control frames 204 from interfaces 600. The switch 602 may queue frames received from interfaces 600, and may monitor and detect congestion in those queues as described earlier. The switch 602 communicates with coprocessor 604. One purpose of the coprocessor 604 is to allow offloading of certain tasks from the switch core engine 602, and thus to allow for faster packet processing and reduced complexity and cost.

A specific embodiment of switch 602 and coprocessor 604 is described below. This embodiment is designed to support both tagging and non-tagging implementations.

Switch chip specifications according to the specific embodiment are set forth below:
Intercept congestion management (“CM”) related and tagged packets, and forward to coprocessor:
   A. CM tagged packets
      Identify based on packet type
      Simply forward packet header (n bytes) to coprocessor. Hold packet (and subsequent packets) in queue until response from coprocessor is received
      Response types: forward, drop, drop header (remove n bytes starting at offset X; replace n bytes starting at offset X with [ . . . ])
      Secondary: switch configuration option to untag: Remove <n> bytes starting with packet type [or starting at offset X]
         Take VLAN tag into account if packet was tagged inside VLAN tag
      Configure option: forward immediately or wait for response from coprocessor
   B. CM related packets
      Identify based on Destination Address and/or packet type
      Forward complete packets to coprocessor
      Response: complete packet with tag identifying which port(s) packet should be sent
Sample packets, as needed, on congested interfaces, and forward samples to coprocessor:
   A. Configurable: sample conditions, sample packet length, sample rate, sample header
   B. Additional information: queue length, queue ID, receive port, transmit port
As needed, send queue status updates to coprocessor, such as:
   A. Queue length exceeds threshold
   B. Queue length below threshold
   C. Queue empty

Interface specifications between switch 602 and coprocessor 604 according to one embodiment are set forth below:
Speed requirements: Fast enough to handle expected load; low latency
Examples: SERDES, XFI, XAUI, PCI-E, multi-lane XFI (e.g., X40)

Coprocessor functions and implementation according to one embodiment are set forth below:
FPGA capable
Read and interpret sample packets
   A. Sample: Match with internal table
   B. Determine if response is to be generated
   C. Generate response and send to switch chip
Handle tagged packets
   A. Read header; extract queue id
   B. If response is needed, create and send to switch chip
   C. Determine if reaction packet should be sent. If so, create and send

In some instances, the coprocessor 604 can be used for a number of other specialized tasks. Examples of these tasks include:
Search operations
Traffic management operations (e.g., queuing, scheduling)
Packet classification
IPSEC offload engine
Mathematical operations

In some instances, the coprocessor 604 can be used as long as interface speed requirements do not exceed certain technical limits. For example:
1% poll rate from 20 ports→20% load on same-speed switch-coprocessor interface
Reduce length of polled packets to increase bandwidth
For intercepted packets, simply transport relevant elements to reduce bandwidth
Option to “stop” traffic in same queue while waiting for response
Coprocessor-directed manipulation of pending packets

At this point, a practitioner of ordinary skill in the art will appreciate a number of advantages associated with the improved congestion management protocol, including those set forth below:
Separate control path and data path allow higher priority and, thus, faster reaction time for congestion management control packets
Simplified receiving endpoint implementation that does not require the protocol to be implemented on receiver side
With respect to switch: allows simplified coprocessor implementation that reduces or eliminates impact on data path (e.g., little or no packet modification, little or no impact on switch latency)
Improved ease of implementing protocol
Improved fairness in data rate adjustment

A practitioner of ordinary skill in the art will also appreciate a number of advantages associated with the improved coprocessor implementation, including those set forth below:
Reduce switch cost
Allows early pre-standard implementation
Simplifies enhancements and allows vendor differentiation

A practitioner of ordinary skill in the art requires no additional explanation in developing the embodiments described herein but may nevertheless find some helpful guidance by examining the following references, the disclosures of which are incorporated by reference in their entireties:
U.S. Pat. No. 7,206,285 (Method for supporting non-linear, highly scalable increase-decrease congestion control scheme)
U.S. Pat. No. 7,016,971 (Congestion management in a distributed computer system multiplying current variable injection rate with a constant to set new variable injection rate at source node)
US 2005/0270974 (System and method to identify and communicate congested flows in a network fabric)
US 2007/0058532 (System and method for managing network congestion)
US 2007/0081454 (Methods and devices for backward congestion notification)
US 2006/0104308 (Method and apparatus for secure internet protocol (IPSEC) offloading with integrated host protocol stack management)
U.S. Pat. No. 6,912,557 (Math coprocessor)

An embodiment of the invention relates to a computer storage product with a computer-readable medium having computer code thereon for performing various computer-implemented operations. The term “computer-readable medium” is used herein to include any medium that is capable of storing or encoding a sequence of instructions or computer codes for performing the operations described herein. The media and computer code may be those specially designed and constructed for the purposes of the invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (“ASICs”), programmable logic devices (“PLDs”), and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Additional examples of computer code include encrypted code and compressed code. Moreover, an embodiment of the invention may be downloaded as a computer program product, which may be transferred from a remote computer (e.g., a server computer) to a requesting computer (e.g., a client computer or a different server computer) by way of data signals embodied in a carrier wave or other propagation medium via a transmission channel. Another embodiment of the invention may be implemented in hardwired circuitry in place of, or in combination with, machine-executable software instructions.

While the invention has been described with reference to the specific embodiments thereof, it should be understood by those skilled in the art that various changes may be made and equivalents may be substituted without departing from the true spirit and scope of the invention as defined by the appended claims. In addition, many modifications may be made to adapt a particular situation, material, composition of matter, method, operation or operations, to the objective, spirit and scope of the invention. All such modifications are intended to be within the scope of the claims appended hereto. In particular, while certain methods may have been described with reference to particular operations performed in a particular order, it will be understood that these operations may be combined, sub-divided, or re-ordered to form an equivalent method without departing from the teachings of the invention. Accordingly, unless specifically indicated herein, the order and grouping of the operations is not a limitation of the invention.

What is claimed is:

1. A network switch comprising:
first logic for receiving a flow, including identifying a reaction point as the source of the data frames included in the flow;
second logic for detecting congestion at the network switch and associating the congestion with the flow and the reaction point;
third logic for generating congestion notification information in response to the congestion;
fourth logic for receiving control information, including identifying the reaction point as the source of the control information; and
fifth logic for addressing the congestion notification information and the control information to the reaction point, wherein the data rate of the flow is based on the congestion notification information and the control information;
wherein the content of the data frames included in the flow is independent of the congestion notification information and the control information in a first mode of the network switch.

2. The network switch of claim 1, wherein the network switch accesses only physical layer and data link layer information within the flow.

3. The network switch of claim 1, wherein the control information includes at least one of a timestamp, a sequence number, and a measured data rate of the flow.

4. The network switch of claim 3, further comprising sixth logic for modifying the measured data rate of the flow.

5. The network switch of claim 1, further comprising:
sixth logic for receiving a bandwidth request associated with the flow, including identifying the reaction point as the source of the bandwidth request; and
seventh logic for generating a response to the bandwidth request, and for addressing the response to the reaction point.

6. The network switch of claim 1, further comprising sixth logic for proactively generating a request to increase the data rate of the flow, and for addressing the request to the reaction point.

7. The network switch of claim 1, wherein the congestion notification information includes at least one of queue level deviation information, queue level change information, and feedback information based on queue level deviation information and queue level change information.

8. The network switch of claim 1, wherein the congestion notification information includes at least one of a suggested data rate for the flow, a link data rate associated with an output interface of the network switch traversed by the flow, a link capacity associated with a queue containing data frames included in the flow, and utilization of an output interface of the network switch traversed by the flow.

9. The network switch of claim 1, wherein the second logic monitors congestion at the network switch per time interval, wherein the length of the time interval is variable based on the level of congestion.

10. The network switch of claim 1, wherein at least one data frame included in the flow includes the control information in a second mode of the network switch.

11. A network switch comprising:
first logic for receiving congestion notification information associated with a congestion point and a flow, wherein the flow is generated by the network switch, and wherein the congestion notification information is addressed to the network switch;
second logic for generating control information and addressing the control information to the congestion point;
third logic for generating the data frames included in the flow, wherein, in a first mode of the network switch, the content of the data frames included in the flow is independent of the congestion notification information and the control information;
fourth logic for receiving the control information; and
fifth logic for determining a data rate of the flow based on the congestion notification information and the control information.

12. The network switch of claim 11, wherein the first logic and the fourth logic access only physical layer and data link layer information.

13. The network switch of claim 11, wherein the control information includes a measured data rate of the flow.

14. The network switch of claim 11, further comprising sixth logic for determining a round-trip time between the network switch and the congestion point based on the control information, wherein the data rate of the flow is determined based on the round-trip time.

15. The network switch of claim 14, wherein the round-trip time is determined based on at least one of a timestamp and a sequence number included in the control information.

16. The network switch of claim 11, further comprising sixth logic for receiving a suggested data rate for the flow, wherein the data rate of the flow is determined based on the suggested data rate.

17. The network switch of claim 11, further comprising sixth logic for receiving congestion status information associated with the congestion point, wherein the data rate of the flow is increased in response to the congestion status information.

18. The network switch of claim 17, wherein the congestion status information includes utilization of an output interface of the congestion point traversed by the flow.

19. The network switch of claim 11, wherein at least one data frame included in the flow includes the control information in a second mode of the network switch.

20. A method comprising:
detecting congestion at a congestion point, wherein a flow causing the congestion originates at a reaction point;
generating congestion notification information based on the congestion, wherein the congestion notification information is addressed to the reaction point;
identifying control information at the congestion point, wherein the control information originates at the reaction point;
returning the control information to the reaction point;
processing the flow, wherein the content of the data frames included in the flow is independent of the congestion notification information;
determining a data rate of the flow based on the congestion notification information and the control information.

21. The method of claim 20, wherein the congestion notification information and the control information are accessible via processing at the data link layer.

22. The method of claim 20, wherein the control information includes a measured data rate of the flow.

23. The method of claim 20, further comprising determining a round-trip time between the reaction point and the congestion point based on the control information, wherein the control information includes at least one of a timestamp and a sequence number.

24. The method of claim 23, wherein determining the data rate of the flow is also based on the round-trip time.
